(19) United States
(12) Patent Application Publication
(10) Pub. No.: US 2014/0237401 A1
(43) Pub. Date: Aug. 21, 2014

(54) INTERPRETATION OF A GESTURE ON A TOUCH SENSING DEVICE

(71) Applicant: FlatFrog Laboratories AB, Lund (SE)

(72) Inventors: Mattias KRUS, Lund (SE); Nicklas OHLSSON, Bunkeflostrand (SE); Andreas OLSSON, Bjarred (SE)

(73) Assignee: FlatFrog Laboratories AB, Lund (SE)

(21) Appl. No.: 14/176,390

(22) Filed: Feb. 10, 2014

Related U.S. Application Data
(60) Provisional application No. 61/765,163, filed on Feb. 15, 2013.

(51) Int. Cl. G06F 3/0488

(52) U.S. Cl. CPC G06F 3/0488
USPC 715/765

(57) ABSTRACT

The disclosure relates to receiving touch input data indicating touch inputs on a touch surface of a touch sensing device, and from the touch input data: determining a touch input from a user object on the touch surface, wherein the touch input has a first area a₁ and a geometric centre at a first position; and while continuous contact of the user object with the touch surface is maintained: determining a change of the geometric centre to a second position; determining a second area a₂ of the touch input when the geometric centre is in the second position; comparing the second area a₂ with the first area a₁, and if the second area a₂ is larger than the first area a₁: determining that a special gesture has been detected; associating the special gesture with the GUI object; and manipulating the GUI object according to a predetermined action.

This application claims priority under 35 U.S.C. §119 to U.S. application No. 61/765,163 filed on Feb. 15, 2013, the entire contents of which are hereby incorporated by reference.

### FIELD OF THE INVENTION

The present invention relates to interpretation of a gesture on a touch surface of a touch sensing device.

### BACKGROUND OF THE INVENTION

Touch sensing systems (“touch systems”) are in widespread use in a variety of applications. Typically, the touch systems are actuated by a touch object such as a finger or stylus, either in direct contact, or through proximity (i.e. without contact), with a touch surface. Touch systems are for example used as touch pads of laptop computers, in control panels, and as overlays to displays on e.g. hand held devices, such as mobile telephones. A touch panel that is overlaid on or integrated in a display is also denoted a “touch screen”. Many other applications are known in the art.

To an increasing extent, touch systems are designed to be able to detect two or more touches simultaneously, this capability often being referred to as “multi-touch” in the art.

There are numerous known techniques for providing multi-touch sensitivity, e.g. by using cameras to capture light scattered off the point(s) of touch on a touch panel, or by incorporating resistive wire grids, capacitive sensors, strain gauges, etc into a touch panel.

WO2011/028169 and WO2011/049512 disclose multi-touch systems that are based on frustrated total internal reflection (FTIR). Light sheets are coupled into a panel to propagate inside the panel by total internal reflection (TIR). When an object comes into contact with a touch surface of the panel, the propagating light is attenuated at the point of touch. The transmitted light is measured at a plurality of outcoupling points by one or more light sensors. The signals from the light sensors are processed for input into an image reconstruction algorithm that generates a 2D representation of interaction across the touch surface. This enables repeated determination of current position/size/shape of touches in the 2D representation while one or more users interact with the touch surface. Examples of such touch systems are found in U.S. Pat. No. 3,673,327, U.S. Pat. No. 4,254,333, U.S. Pat. No. 6,972,753, US2004/0252091, US2006/0114237, US2007/0075648, WO2009/048365, US2009/0153519, WO2010/006882, WO2010/064983, and WO2010/134865.

A touch screen provided with a multi-touch technology can usually be oriented in any direction. A tabletop computer is normally placed in a horizontal position. If the tabletop computer is provided with a touch screen with multi-touch technology and several users are interacting with the computer, there might be a need to orient items presented via the touch screen towards the different users. An item often has a desired orientation for it to be presented to the user. For example, a text message shall preferably be oriented non-inverted to a user, or if a picture comprises e.g. an ocean and a sky, the ocean shall be in a lower part and the sky in an upper part of the picture as seen from the user.

In US-20120060127-A1 this problem is solved by using a touch sensing technology using a camera to detect the palm of a hand in relation to the fingers of the hand. The hand direction of a user is recognized and an item is oriented according to the hand direction.

In US-2007/0300182-A1 orientation of a user is determined using a point of contact that an object, e.g. a finger of the user, makes against a display surface and a shadow cast by the object on the surface. An axis is determined between the shadow and the point of contact and the axis is used as a frame of reference for the orientation of an interface element. A camera is used to detect the point of contact and the shadow.

Several users may interact at the same time with a touch system, and if a user wants the system to react in a certain way the input to the system should preferable be fast and intuitive for the user.

In view of the foregoing, it is an object of the invention to provide a new gesture for manipulation an item visible via the touch screen. It is a further object to provide a gesture for orienting the item in a predetermined direction in relation to the gesture.

### SUMMARY OF THE INVENTION

According to a first aspect, the object is at least partly achieved with a method for manipulating a graphical user interface, GUI, object according to the first independent claim. The method comprises receiving touch input data indicating touch inputs on a touch surface of a touch sensing device, and from the touch input data:
determining a touch input from a user object on the touch surface, wherein the touch input has a first area a₁ and a geometric centre at a first position; and while continuous contact of said user object with the touch surface is maintained:
determining a change of the geometric centre to a second position;
determining a second area a₂ of the touch input when the geometric centre is in the second position;
comparing the second area a₂ with the first area a₁, and if the second area a₂ is larger than the first area a₁:
determining that a special gesture has been detected;
associating the special gesture with the GUI object; and
manipulating the GUI object according to a predetermined action.

The method enables detection of a special gesture made by a user. The special gesture is accomplished by the user by touching the touch surface with e.g. a finger and thereafter laying down the finger on the touch surface. The gesture is easy to remember and to make, and is versatile in that it can be used to manipulate an object in a predetermined way according to an action.

According to one embodiment, the method comprising determining a user object vector kᵤₛₑᵣ connecting the first position with the second position. If the user object is e.g. a finger of the user, the orientation of the user object vector kᵤₛₑᵣ will be related to the orientation of the user. According to a further embodiment, the GUI object has an orientation vector k_{GUI}, wherein performing the action includes orienting the GUI object in a predetermined relation between the user object vector kᵤₛₑᵣ and the orientation vector k_{GUI}. Thus, the GUI object may be re-oriented such that it is displayed to the user in a predetermined orientation.

According to another embodiment, the user object vector kᵤₛₑᵣ has a length L, and wherein the method comprises comparing the length L with a threshold, and determining that a special gesture has been detected also based on the comparison. Thus, a further requirement for determining the special gesture is achieved. The threshold is for example a length related to the anatomy of a finger. According to another embodiment, the threshold depends on the size of the first area a₁ and/or the size of the second area a₂.

According to a further embodiment, the method comprises determining if the second area a₂ of the touch input has the shape of an oval. A further condition for determining that a special gesture has been detected is then that the second area a₂ has the shape of an oval. The oval may have the same area as the area of a fingerprint, i.e. an area of the part of the fingerpalm that touches the touch surface when the fingerpalm is pressed against the surface. The area a₂ preferably also has an elongated shape.

According to another embodiment, the method comprises determining if the first area a₁ and the second area a₂ at least partly overlap, whereby a further condition for determining that a special gesture has been detected is that the first area a₁ and the second area a₂ overlap. According to a still further embodiment, the method comprises determining if the second area a₂ covers the first position of the geometric centre. A further condition for determining that a special gesture has been detected is then that the second area a₂ covers the first position of the geometric centre.

According to a further embodiment, the method comprises determining a velocity of the geometric centre when moving from the first position to the second position and determining if the velocity is within a certain velocity interval, whereby a further condition for determining that a special gesture has been detected is that the velocity is within the interval.

Thus, more prerequisites for determining that a special gesture has been made are achieved. The special gesture can thereby be distinguished from other gestures and inputs on the touch surface.

According to a still further embodiment, the method comprises determining from the touch input data that an increased pressure compared to a threshold of the touch input has occurred, before determining that a special gesture has been determined. Thus, the special gesture may be further characterized by an increased pressure.

According to one embodiment, the touch input data comprises positioning data xₙₜ, yₙₜ and area data aₙₜ for each touch input. According to a further embodiment, the touch input data also comprises pressure data pₙₜ for each touch input. The positioning data may for example be a geometric centre of a touch input. The pressure data is according to one embodiment the total pressure, or force, of the touch input. According to another embodiment, the pressure data is a relative pressure.

According to a second aspect, the object is at least partly achieved with a gesture interpretation unit for manipulation of a graphical user interface, GUI, object. The unit comprises a processor configured to receive touch input data indicating touch inputs on a touch surface of a touch sensing device. The unit further comprises a computer readable storage medium storing instructions operable to cause the processor to perform operations comprising:
determining a touch input from a user object on the touch surface, wherein the touch input has a first area a₁ and a geometric centre at a first position; and while continuous contact of the user object with the touch surface is maintained:
determining a change of the geometric centre to a second position;
determining a second area a₂ of the touch input when the geometric centre is in the second position;
comparing the second area a₂ with the first area a₁, and if the second area a₂ is larger than the first area a₁:
determining that a special gesture has been detected;
associating the special gesture with the GUI object; and
manipulating the GUI object according to a predetermined action.

Thus, a unit is achieved where the method according to the first aspect can be implemented.

According to a third aspect, the object is at least partly achieved with a touch sensing device comprising:
a touch arrangement comprising a touch surface, wherein the touch arrangement is configured to detect touch inputs on the touch surface and to generate a signal s_{y} indicating the touch inputs;
a touch control unit configured to receive the signal s_{y} and to determine touch input data from said touch inputs and to generate a touch signal sₓ indicating the touch input data;
a gesture interpretation unit according to any of the embodiments as described herein, wherein the gesture interpretation unit is configured to receive the touch signal sₓ.

According to one embodiment, the touch sensing device is an FTIR-based (Frustrated Total Internal Reflection) touch sensing device.

According to a fourth aspect, the object is at least partly achieved with a computer readable storage medium comprising computer programming instructions which, when executed on a processor, are configured to carry out the method as described herein.

Any of the above-identified embodiments of the method may be adapted and implemented as an embodiment of the second, third and/or fourth aspects. Thus, the gesture interpretation unit may include instructions to carry out any of the methods as described herein.

Preferred embodiments are set forth in the dependent claims and in the detailed description.

### SHORT DESCRIPTION OF THE APPENDED DRAWINGS

Below the invention will be described in detail with reference to the appended figures, of which:

FIG. 1 illustrates a touch sensing device according to some embodiments of the invention.

FIG. 2 is a flowchart of the method according to some embodiments of the invention.

FIGS. 3A-3B illustrates a touch surface of a device when a GUI object is presented via the GUI of the device and a gesture according to some embodiments of the invention.

FIG. 3C illustrates the first area a₁ and the second area a₂ made on the touch surface when the gesture as illustrated in FIGS. 3A-3B is performed.

FIG. 4A illustrates a side view of a touch sensing arrangement.

FIG. 4B is a top plan view of an embodiment of the touch sensing arrangement of FIG. 4A.

FIG. 5 is a flowchart of a data extraction process in the device of FIG. 4B.

FIG. 6 is a flowchart of a force estimation process that operates on data provided by the process in FIG. 5.

### DETAILED DESCRIPTION OF PREFERRED EMBODIMENTS OF THE INVENTION

### 1. Device

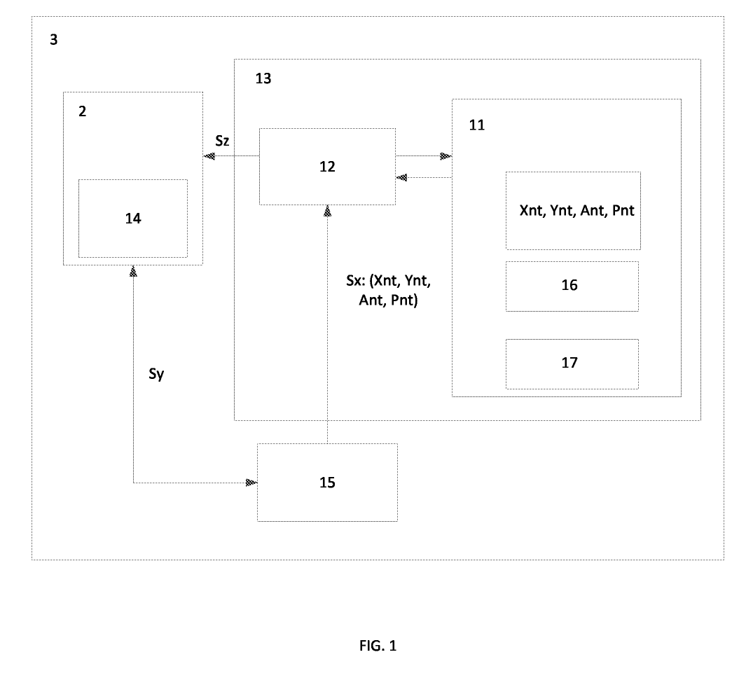

FIG. 1 illustrates a touch sensing device 3 according to some embodiments of the invention. The device 3 includes a touch arrangement 2, a touch control unit 15, and a gesture interpretation unit 13. These components may communicate via one or more communication buses or signal lines. According to one embodiment, the gesture interpretation unit 13 is incorporated in the touch control unit 15, and they may then be configured to operate with the same processor and memory. The touch arrangement 2 includes a touch surface 14 that is sensitive to simultaneous touches. A user can touch on the touch surface 14 to interact with a graphical user interface (GUI) of the touch sensing device 3. The device 3 can be any electronic device, portable or non-portable, such as a computer, gaming console, tablet computer, a personal digital assistant (PDA) or the like. It should be appreciated that the device 3 is only an example and the device 3 may have more components such as RF circuitry, audio circuitry, speaker, microphone etc. and be e.g. a mobile phone or a media player etc.

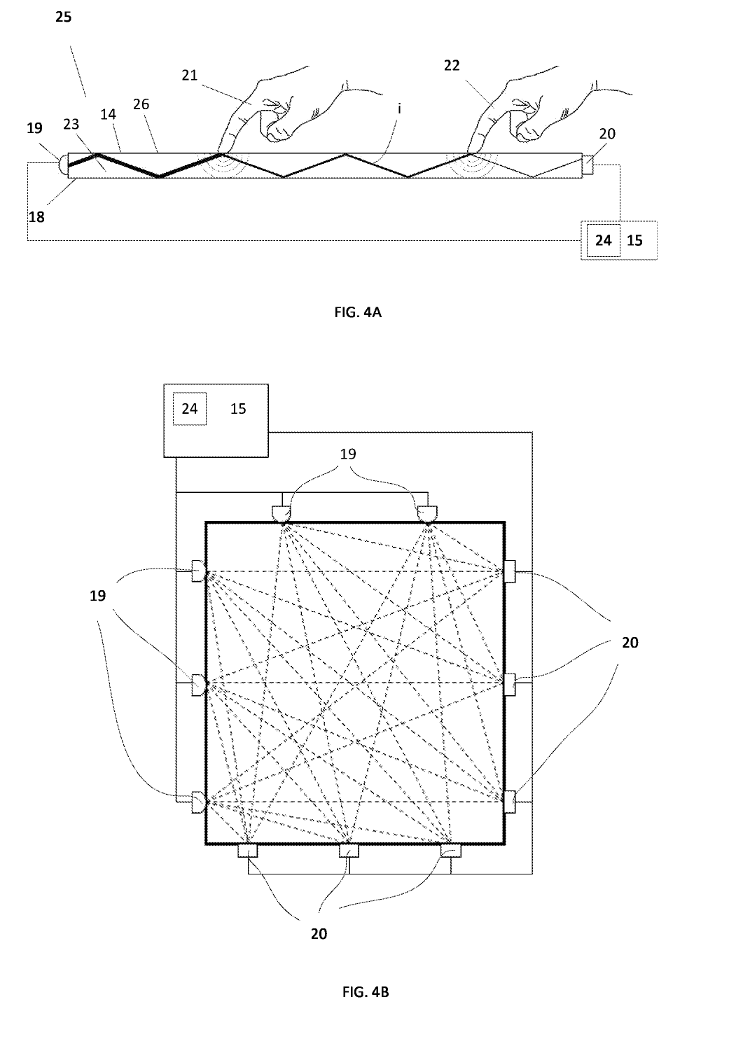

The touch surface 14 may be part of a touch sensitive display, a touch sensitive screen or a light transmissive panel 23 (FIG. 4A-4B). With the last alternative the light transmissive panel 23 is then overlaid on or integrated in a display and may be denoted a “touch sensitive screen”, or only “touch screen”. The touch sensitive display or screen may use LCD (Liquid Crystal Display) technology, LPD (Light Emitting Polymer) technology, OLED (Organic Light Emitting Diode) technology or any other display technology. The GUI displays visual output to the user via the display, and the visual output is visible via the touch surface 14. The visual output may include text, graphics, video and any combination thereof.

The touch surface 14 is configured to receive touch inputs from one or several users. The touch arrangement 2, the touch surface 14 and the touch control unit 15 together with any necessary hardware and software, depending on the touch technology used, detect the touch inputs. The touch arrangement 2, the touch surface 14 and touch control unit 15 may also detect touch inputs including movement of the touch inputs using any of a plurality of known touch sensing technologies capable of detecting simultaneous contacts with the touch surface 14, i.e. touches on the touch surface 14. Such technologies include capacitive, resistive, infrared, and surface acoustic wave technologies. An example of a touch technology which uses light propagating inside a panel will be explained in connection with FIG. 4A-4B.

The touch arrangement 2 is configured to generate and send the touch inputs as one or several signals s_{y} to the touch control unit 15. The touch control unit 15 is configured to receive the one or several signals s_{y} and comprises software and hardware to analyse the received signals s_{y}, and to determine touch input data including sets of positions xₙₜ, yₙₜ, area data aₙₜ and pressure data pₙₜ on the touch surface 14 by processing the signal s_{y}. Each set of touch input data xₙₜ, yₙₜ, aₙₜ, pₙₜ may also include identification, an ID, identifying to which touch input the data pertain. Here “n” denotes the identity of the touch input. If the touch input is still or moved over the touch surface 14, without losing contact with it, a plurality of touch input data xₙₜ, yₙₜ, aₙₜ, pₙₜ with the same ID will be determined. If the touch input is taken away from the touch surface 14, there will be no more touch input data with this ID. A position may also be referred to as a location. A position xₙₜ, yₙₜ referred to herein is according to one embodiment a geometric centre of the area aₙₜ. The touch control unit 15 is further configured to generate one or several touch signals sₓ comprising the touch input data, and to send the touch signals sₓ to a processor 12 in the gesture interpretation unit 13. The processor 12 may e.g. be a computer programmable unit (CPU). The gesture interpretation unit 13 also comprises a computer readable storage medium 11, which may include a volatile memory such as high speed random access memory (RAM-memory) and/or a non-volatile memory such as a flash memory.

The computer readable storage medium 11 comprises a touch module 16 (or set of instructions), and a graphics module 17 (or set of instructions). The computer readable storage medium 11 comprises computer programming instructions which, when executed on the processor 12, are configured to carry out the method according to any of the steps described herein. These instructions can be seen as divided between the modules 16, 17. The computer readable storage medium 11 may also store received touch input data comprising positions xₙₜ, yₙₜ on the touch surface 14, area aₙₜ and pressure pₙₜ of the touch inputs with their IDs, respectively. The touch module 16 includes instructions to determine from the touch input data if the touch inputs have certain characteristics, such as being in a predetermined relation to each other and/or a GUI object 1, and/or if one or several of the touch inputs is/are moving, and/or if continuous contact with the touch surface 14 is maintained or is stopped, and/or the pressure of the one or several touch inputs. The touch module 16 thus keeps track of the touch inputs. Determining movement of a touch input may include determining a speed (magnitude), velocity (magnitude and direction) and/or acceleration (magnitude and/or direction) of the touch input or inputs.

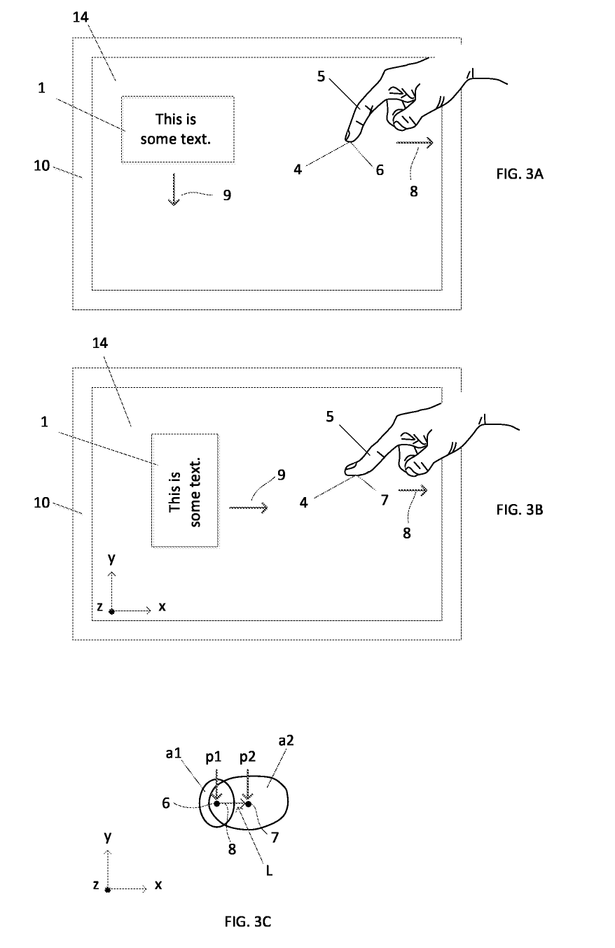

The graphics module 17 includes instructions for rendering and displaying graphics via the GUI. The graphics module 17 controls the position, movements, and actions etc. of the graphics. More specifically, the graphics module 17 includes instructions for displaying at least one GUI object 1 (FIG. 3A-3C) on or via the GUI, associating a determined special gesture with the GUI object, and manipulating the GUI object according to a predetermined action. Thus, the touch module 16 is configured to determine fulfillment of the steps according to the herein described method to determine the “special gesture”, and upon fulfillment the graphics module 17 manipulates the associated GUI object or objects according to a predetermined action. The processor 12 is configured to generate signals s_{z} or messages including the predetermined action. The processor 12 is further configured to send the signals s_{z} or messages to the touch arrangement 2, where the GUI via a display is configured to receive the signals s_{z} or messages and manipulate the GUI object 1 according to the predetermined action. Examples of predetermined actions will be described in the following.

The term “graphical” include any visual object that can be presented on the GUI and be visible for the user, such as text, icons, digital images, animations or the like. A GUI object can also include the whole visible user interface. Thus, if the user makes touch inputs on the touch surface 14 according to the method, a GUI object 1 will react to the touch inputs as will be explained in the following. The gesture interpretation unit 13 may be incorporated in any known touch sensing device 3 with a touch surface 14, wherein the device 3 is capable of presenting the GUI object 1 via a GUI visible on the touch surface 14, detect touch inputs on the touch surface 14 and to generate and deliver touch input data to the processor 12. The gesture interpretation unit 13 is then incorporated into the device 3 such that it can manipulate the GUI object 1 in predetermined ways when certain touch data has been determined.

### 2. Gesture

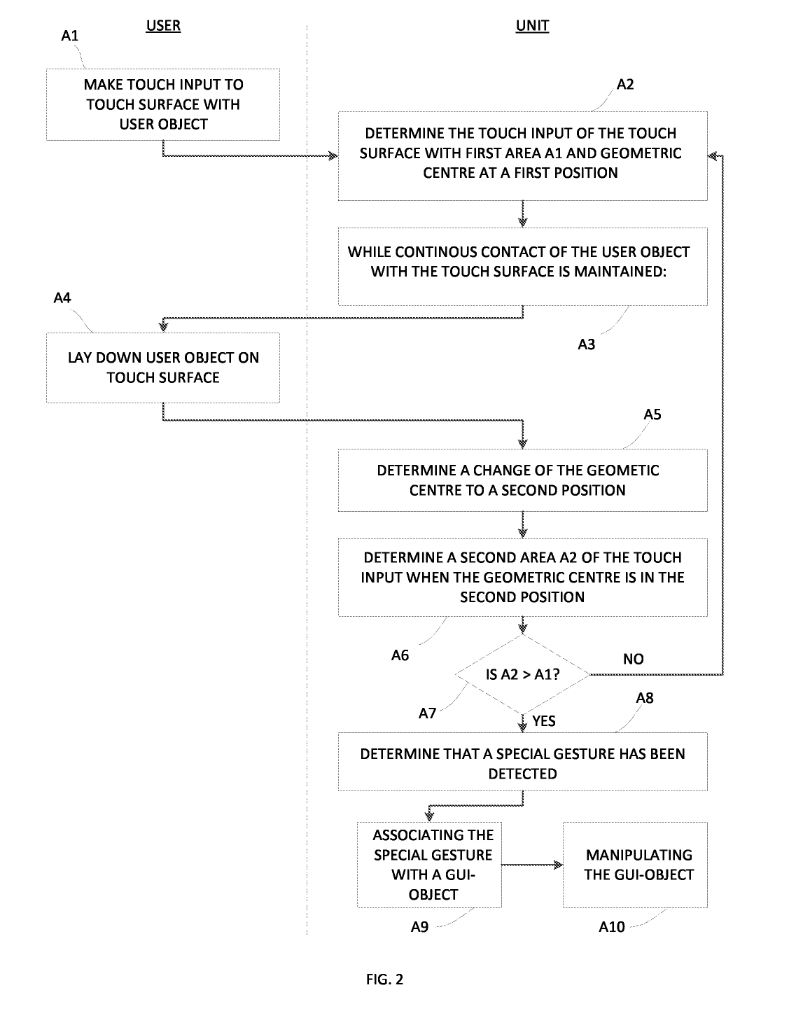

FIG. 2 is a flowchart illustrating a method according to some embodiments of the invention, when a user makes certain touch inputs to the touch surface 14 according to a certain pattern. The left side of the flowchart in FIG. 2 illustrates the touch inputs made by a user, and the right side of the flowchart illustrates how the gesture interpretation unit 13 responds to the touch inputs. The left and the right sides of the flowchart are separated by a dotted line. The method may be preceded by setting the touch sensing device 3 in a certain state. This certain state may invoke the function of the gesture interpretation unit 13, whereby the method which will now be described with reference to FIG. 2 can be executed.

As a start, a GUI object 1 is shown via the GUI of the touch sensing device 3. Alternatively, the GUI object 1 is not yet visible via the GUI, but will be upon making a special gesture. The user may now initiate interaction with the GUI object 1 by making certain touch inputs on the touch surface 14. To make the special gesture the user starts by making a touch input 4 on the touch surface 14 with a user object 5 (A1). The user object 5 may e.g. be a finger of the user or another object that can be laid down on the touch surface 14. The touch input 4 from the user object 5 on the touch surface 14 is thereafter determined (A2), wherein the touch input 4 has a first area a₁ and a geometric centre at a first position 6. While continuous contact of the user object 5 with the touch surface 14 is maintained (A3), the user object 5 is laid down on the touch surface 14 (A4). The method determines that the finger has been laid down by determining a change of the geometric centre to a second position 7 (A5). When the geometric centre is in the second position a second area a₂ of the touch input 4 is determined (A6). The second area a₂ is then compared with the first area a₁, and if the second area a₂ is larger than the first area a₁ (A7) it is determined that a special gesture has been detected (A8). The special gesture is associated with the GUI object 1 (A9) and the GUI object 1 is manipulated according to a predetermined action (A10). Examples of actions will be described in the following. If the second area a₂ is not larger than the first area a₁ (A7) it is determined that no special gesture can be determined. The method then returns to step A2.

FIGS. 3A-3B illustrates when a user makes the special gesture on the touch surface 14 according to some embodiments of the invention. The touch surface 14 is part of the touch arrangement 2 (FIG. 1), and is here provided with a frame 10 as illustrated in the figures. In the figures a GUI object 1 is shown in the shape of a text field with the text “This is some text”. The text shall only be seen as illustrating the invention, and not to be limiting in this context. The GUI object 1 has according to one embodiment an orientation vector k_{GUI} 9, in which direction the GUI object 1 is intended to be presented to a user. Thus, to be non-inverted to a user, the orientation vector k_{GUI} 9 shall point in the direction of the user.

As can be seen in FIG. 3A, the user makes a touch input 4 with her finger 5 on the touch surface 14 at a first position 6 on the touch surface 14. All touch inputs on the touch surface 14 are detected by the touch control module 15 (FIG. 1) and sent to the processor 12 in the gesture interpretation unit 13 in the shape of touch input data xₙₜ, yₙₜ, area data aₙₜ and in some embodiments pressure data pₙₜ for each touch input. Thus, the touch input data from the touch input 4 can be retrieved to the processor 12 as a trace with touch input data in subsequent time steps. Traces received to the processor 12 are analysed to see if they have the pattern as illustrated in any of the embodiments as described herein. The touch module 16 (FIG. 1) includes instructions to cause the processor 12 to perform this analysis. Thus, the touch input 4 from the finger 5 on the touch surface 14 is determined, wherein the touch input 4 has a first area a₁ and a geometric centre at a first position 6. The first area a₁ may have the shape of a fingertip. The geometric centre can be determined using one of a plurality of known methods for determining a geometric centre from an area a₁. According to one embodiment the geometric centre is the same as the position coordinates retrieved with the touch input data. The user continues to hold her finger 5 at the touch surface 14 and, as illustrated in FIG. 3B, then lays down her finger 5 on the touch surface 14 such that the fingerpad or at least part of the fingerpad touches the touch surface 14. A change of the geometric centre to a second position can then be determined. A second area a₂ of the touch input 4 when the geometric centre is in the second position 7 is then determined. The second area a₂ of the touch input 4 has according to one embodiment the shape of an oval, e.g. a fingerprint, or fingerpad. A further condition for determining that a special gesture has been detected is then that it can be determined that the second area a₂ has the shape of an oval. The second area a₂ can also be characterized by having an elongated shape. In the FIGS. 3A-3B, the orientation of a user is indicated by the arrow 8. The second area a₂ is compared with the first area a₁, and if the second area a₂ is larger than the first area a₁ it is determined that a special gesture has been detected. The special gesture is associated with the GUI object 1, here a text field, after which the GUI object 1 is manipulated according to a predetermined action. As seen in the FIG. 3B, the text field 1 is now oriented non-inverted towards the user. Thus, when a user makes the special gesture, the GUI object can be oriented to the user. An action may be chosen from a plurality of possible interactions with an object. For example, an action may include popping up, i.e. displaying, the GUI object 1 on the touch surface 14, making the GUI object 1 disappear, moving the GUI object 1 to a certain location on the touch surface 14, orienting the GUI object 1 in a certain direction or making a state change of the GUI object 1 such as changing colour etc. The GUI object 1 is according to one embodiment the whole user interface, and an action may then be to make the whole user interface change direction.

According to one embodiment, the method comprises determining a user object vector kᵤₛₑᵣ 8 connecting the first position 6 with the second position 7. In FIG. 3C, the first area a₁ is illustrated with its geometric centre at a first position 6, and the second area a₂ with its geometric centre at the second position 7. The user object vector kᵤₛₑᵣ 8 is illustrated in the figure as a line connecting the first position 6 with the second position 7. The orientation of kᵤₛₑᵣ is directed from the first position 6 to the second position 7.

The GUI object 1 has according to one embodiment an orientation vector k_{GUI} 9 as illustrated in FIGS. 3A-3B; wherein performing the action includes orienting the GUI object 1 in a predetermined relation between the user object vector kᵤₛₑᵣ 8 and the orientation vector k_{GUI} 9. The vectors kᵤₛₑᵣ 8 and k_{GUI} 9 are here present in the same x-y-plane as illustrated in the figures. The x-y-plane of the vectors are parallel to the plane of the touch surface 14. This action is illustrated in FIG. 3B, where the text field 1 is oriented against the user.

The user object vector kᵤₛₑᵣ 8 has according to one embodiment a length L. This length L can be determined by calculating the distance between the positions 6, 7 of the geometric centres. The method may then comprise comparing the length L with a threshold; and determining that a special gesture has been detected also based on the comparison. The threshold is for example a length related to the anatomy of a finger, e.g. a length of the fingerpalm. The length of the fingerpalm of any person will never have a length exceeding 50 mm. Thus, the gesture can be further distinguished by having a length L of the vector kᵤₛₑᵣ 8 not exceeding a threshold of 50 mm.

In FIG. 3C, the second area a₂ covers the first position 6 of the geometric centre. Thus, as a further requirement for determining the special gesture according to one embodiment, the second area a₂ must cover the first position 6 of the geometric centre. The gesture interpretation unit 13 then comprises instructions for determining if the second area a₂ covers the first position 6 of the geometric centre. The first area a₁ can thus be an area of a fingertip, and the second area a₂ an area of the fingerpalm of the same finger. In some embodiments, it is a sufficient condition that the second area a₂ is sufficiently close to the first position 6. With sufficiently close is meant within a certain distance. For example, the part of the perimeter of the area a₂ that is closest to the first position 6 of the first area a₁ shall be within a certain distance to the first position 6, e.g. between 0 to 20 mm.

According to one embodiment, the threshold for the distance L between the positions 6, 7 of the geometric centre depends on the size of the first area a₁ and/or the size of the second area a₂. The threshold may be a factor multiplied with a square root of the first area a₁ or multiplied with a square root of the second area a₂, respectively, e.g. a factor 1, 1.5 or 2. The first area a₁ is e.g. between 10-300 mm². If the first area a₁ then is 40 mm² and the factor is 1.5, the threshold will be approximately 10 mm. Thus, in this case the distance L has to be smaller than 10 mm. Correspondingly, a threshold for L depending on the second area a₂ can also be determined. The threshold may instead be a factor of a diameter of a circle with the area a₁ or a₂, or any of the axes of an ellipse with the approximate shape of a fingertip with the area a₁, or the approximate shape of a fingerpad with the area a₂. According to another embodiment, a further condition for determining that a special gesture has been made on the touch surface 14, is that the first area a₁ and the second area a₂ at least partly overlap. The gesture interpretation unit 13 then comprises instructions for determining if the first area a₁ and the second area a₂ at least partly overlap. The herein described embodiments can also be combined to further define combined characterising features for the gesture.

According to a further embodiment, the gesture is characterized by a velocity of the geometric centre when moving from the first position 6 to the second position 7 within a certain interval. The velocity is then determined and compared with the upper and lower limits of the interval to determine if the velocity is within the interval. If the velocity is within the interval, it is then determined that the special gesture has been made and has been detected. The certain velocity interval is e.g. 20-200 mm/s. Thus, a further prerequisite for determining a special gesture is that the gesture is made with a certain velocity. Consequently, if the user object 5 is a finger, it has to be laid down to the touch surface 14 with a certain velocity. According to another embodiment, the second area a₂ must be determined within a certain time interval after the initial touch input to the touch surface was made, i.e. within a certain time after the first area a₁ has been determined. The certain time interval is preferably between 0-4 s, e.g. 1-2, 1-3 or 1-4 s. Thus, the special gesture will then be a distinct gesture separated from routine-like nonspecific inputs.

The special gesture may be further characterized by one or several pressures. The user may exert pressure on the touch surface 14 when making the gesture, thus, pressing on the touch surface 14 at some time during the gesture. Thus, the method comprises according to one embodiment to determine from the touch input data that an increased pressure compared to a threshold of the touch input 4 has occurred, before determining that a special gesture has been determined. For example, a user may touch the touch surface 14 with a fingertip 5, press on the touch surface 14 with a pressure p₁ (FIG. 3C) and thereafter lay down the finger 5 against the surface 14. According to another example, the user may touch the touch surface 14 with a fingertip 5, lay down the finger 5 against the surface 14, and then press on the touch surface 14 with a pressure p₂. Of course, the user may press both with pressure p₁ and p₂, and the gesture may be characterized by determining both pressures before a special gesture can be determined. The user may also or instead press with the finger while the finger is laid down on the touch surface 14, such that a pressure continuously can be determined while the gesture is performed. Thus, the gesture may be further characterised by one or several pressures. The pressure may be the total pressure, or force, of the touch input. According to another embodiment, the pressure data is a relative pressure, or relative force, of the touch input.

In the text and figures it is referred to only one GUI object 1, but it is understood that a plurality of independent GUI objects 1 may be displayed via the GUI at the same time and that one or several users may manipulate different GUI objects 1 independently of each other as explained herein.

### 3. Touch Technology Based on FTIR

As explained before, the invention can be used together with several kinds of touch technologies. One kind of a known touch technology based on FTIR will now be explained. The touch technology can advantageously be used together with the invention to deliver touch input data xₙₜ, yₙₜ, aₙₜ, aₙₜ, pₙₜ to the processor 12 of the gesture interpretation unit 13 (FIG. 1).

In FIG. 4A a side view of an exemplifying arrangement 25 for sensing touches in a known touch sensing device is shown. The arrangement 25 may e.g. be part of the touch arrangement 2 illustrated in FIG. 1A. The arrangement 25 includes a light transmissive panel 23, a light transmitting arrangement comprising one or more light emitters 19 (one shown) and a light detection arrangement comprising one or more light detectors 20 (one shown). The panel 23 defines two opposite and generally parallel top and bottom surfaces 26, 18 and may be planar or curved. In FIG. 4A, the panel 23 is rectangular, but it could have any extent. A radiation propagation channel is provided between the two boundary surfaces 26, 18 of the panel 23, wherein at least one of the boundary surfaces 26, 18 allows the propagating light to interact with one or several touching object 21, 22. Typically, the light from the emitter(s) 19 propagates by total internal reflection (TIR) in the radiation propagation channel, and the detector(s) 20 are arranged at the periphery of the panel 23 to generate a respective output signal which is indicative of the energy of received light.

As shown in the FIG. 4A, the light may be coupled into and out of the panel 23 directly via the edge portions of the panel 23 which connects the top 26 and bottom surfaces 18 of the panel 23. The previously described touch surface 14 is according to one embodiment at least part of the top surface 26. The detector(s) 20 may instead be located below the bottom surface 18 optically facing the bottom surface 18 at the periphery of the panel 23. To direct light from the panel 23 to the detector(s) 20, coupling elements might be needed. The detector(s) 20 will then be arranged with the coupling element(s) such that there is an optical path from the panel 23 to the detector(s) 20. In this way, the detector(s) 20 may have any direction to the panel 23, as long as there is an optical path from the periphery of the panel 23 to the detector(s) 20. When one or several objects 21, 22 is/are touching a boundary surface of the panel 23, e.g. the touch surface 14, part of the light may be scattered by the object(s) 21, 22, part of the light may be absorbed by the object(s) 21, 22 and part of the light may continue to propagate unaffected. Thus, when the object(s) 21, 22 touches the touch surface 14, the total internal reflection is frustrated and the energy of the transmitted light is decreased. This type of touch-sensing apparatus is denoted “FTIR system” (FTIR—Frustrated Total Internal Reflection) in the following. A display may be placed under the panel 23, i.e. below the bottom surface 18 of the panel. The panel 23 may instead be incorporated into the display, and thus be a part of the display.

The location of the touching objects 21, 22 may be determined by measuring the energy of light transmitted through the panel 23 on a plurality of detection lines. This may be done by e.g. operating a number of spaced apart light emitters 19 to generate a corresponding number of light sheets into the panel 23, and by operating the light detectors 20 to detect the energy of the transmitted energy of each light sheet. The operating of the light emitters 19 and light detectors 20 may be controlled by a touch processor 24. The touch processor 24 is configured to process the signals from the light detectors 20 to extract data related to the touching object or objects 21, 22. The touch processor 24 is part of the touch control unit 15 as indicated in the figures. A memory unit (not shown) is connected to the touch processor 24 for storing processing instructions which, when executed by the touch processor 24, performs any of the operations of the described method.

The light detection arrangement may according to one embodiment comprise one or several beam scanners, where the beam scanner is arranged and controlled to direct a propagating beam towards the light detector(s).

As indicated in FIG. 4A, the light will not be blocked by a touching object 21, 22. If two objects 21 and 22 happen to be placed after each other along a light path from an emitter 19 to a detector 20, part of the light will interact with both these objects 21, 22. Provided that the light energy is sufficient, a remainder of the light will interact with both objects 21, 22 and generate an output signal that allows both interactions (touch inputs) to be identified. Normally, each such touch input has a transmission in the range 0-1, but more usually in the range 0.7-0.99. The total transmission t, along a light path i is the product of the individual transmissions tₖ of the touch points on the light path: tᵢ=Πₖ₌₁ⁿ tₖ. Thus, it may be possible for the touch processor 24 to determine the locations of multiple touching objects 21, 22, even if they are located in the same line with a light path.

FIG. 4B illustrates an embodiment of the FTIR system, in which a light sheet is generated by a respective light emitter 19 at the periphery of the panel 23. Each light emitter 19 generates a beam of light that expands in the plane of the panel 23 while propagating away from the light emitter 19. Arrays of light detectors 20 are located around the perimeter of the panel 23 to receive light from the light emitters 19 at a number of spaced apart outcoupling points within an outcoupling site on the panel 23. As indicated by dashed lines in FIG. 4B, each sensor-emitter pair 19, 20 defines a detection line. The light detectors 20 may instead be placed at the periphery of the bottom surface 18 of the touch panel 23 and protected from direct ambient light propagating towards the light detectors 20 at an angle normal to the touch surface 14. One or several detectors 20 may not be protected from direct ambient light, to provide dedicated ambient light detectors.

The detectors 20 collectively provide an output signal, which is received and sampled by the touch processor 24. The output signal contains a number of sub-signals, also denoted “projection signals”, each representing the energy of light emitted by a certain light emitter 19 and received by a certain light sensor 20. Depending on implementation, the processor 24 may need to process the output signal for separation of the individual projection signals. As will be explained below, the processor 24 may be configured to process the projection signals so as to determine a distribution of attenuation values (for simplicity, referred to as an “attenuation pattern”) across the touch surface 14, where each attenuation value represents a local attenuation of light.

### 4. Data Extraction Process in an FTIR System

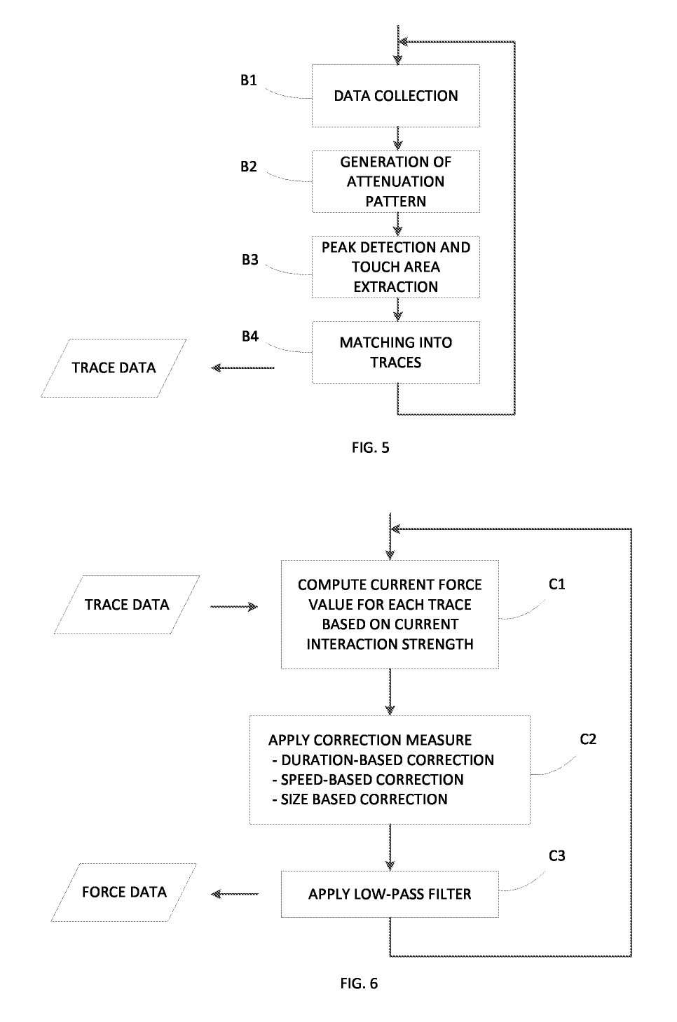

FIG. 5 is a flow chart of a data extraction process in an FTIR system. The process involves a sequence of steps B1-B4 that are repeatedly executed, e.g. by the touch processor 24 (FIG. 4A). In the context of this description, each sequence of steps B1-B4 is denoted a frame or iteration. The process is described in more detail in the Swedish application No 1251014-5, filed on Sep. 11, 2012, which is incorporated herein in its entirety by reference.

Each frame starts by a data collection step B1, in which measurement values are obtained from the light detectors 20 in the FTIR system, typically by sampling a value from each of the aforementioned projection signals. The data collection step B1 results in one projection value for each detection line. It may be noted that the data may, but need not, be collected for all available detection lines in the FTIR system. The data collection step B1 may also include pre-processing of the measurement values, e.g. filtering for noise reduction.

In a reconstruction step B2, the projection values are processed for generation of an attenuation pattern. Step B2 may involve converting the projection values into input values in a predefined format, operating a dedicated reconstruction function on the input values for generating an attenuation pattern, and possibly processing the attenuation pattern to suppress the influence of contamination on the touch surface (fingerprints, etc.).

In a peak detection step B3, the attenuation pattern is then processed for detection of peaks, e.g. using any known technique. In this step a touch area of the detected peak is also extracted, as explained below. In one embodiment, a global or local threshold is first applied to the attenuation pattern, to suppress noise. Any areas with attenuation values that fall above the threshold may be further processed to find local maxima. The identified maxima may be further processed for determination of a touch shape and a center position, e.g. by fitting a two-dimensional second-order polynomial or a Gaussian bell shape to the attenuation values, or by finding the ellipse of inertia of the attenuation values. There are also numerous other techniques as is well known in the art, such as clustering algorithms, edge detection algorithms, standard blob detection, water shedding techniques, flood fill techniques, etc. Step B3 results in a collection of peak data, which may include values of position, attenuation, size, area and shape for each detected peak. The attenuation may be given by a maximum attenuation value or a weighted sum of attenuation values within the peak shape.

In a matching step B4, the detected peaks are matched to existing traces, i.e. traces that were deemed to exist in the immediately preceding frame. A trace represents the trajectory for an individual touching object on the touch surface as a function of time. As used herein, a “trace” is information about the temporal history of an interaction. An “interaction” occurs when the touch object affects a parameter measured by a sensor. Touches from an interaction detected in a sequence of frames, i.e. at different points in time, are collected into a trace. Each trace may be associated with plural trace parameters, such as a global age, an attenuation, a location, a size, a location history, a speed, etc. The “global age” of a trace indicates how long the trace has existed, and may be given as a number of frames, the frame number of the earliest touch in the trace, a time period, etc. The attenuation, the location, and the size of the trace are given by the attenuation, location and size, respectively, of the most recent touch in the trace. The “location history” denotes at least part of the spatial extension of the trace across the touch surface, e.g. given as the locations of the latest few touches in the trace, or the locations of all touches in the trace, a curve approximating the shape of the trace, or a Kalman filter. The “speed” may be given as a velocity value or as a distance (which is implicitly related to a given time period). Any known technique for estimating the tangential speed of the trace may be used, taking any selection of recent locations into account. In yet another alternative, the “speed” may be given by the reciprocal of the time spent by the trace within a given region which is defined in relation to the trace in the attenuation pattern. The region may have a pre-defined extent or be measured in the attenuation pattern, e.g. given by the extent of the peak in the attenuation pattern.

The matching step B4 may be based on well-known principles and will not be described in detail. For example, step B4 may operate to predict the most likely values of certain trace parameters (location, and possibly size and shape) for all existing traces and then match the predicted values of the trace parameters against corresponding parameter values in the peak data produced in the peak detection step B3. The prediction may be omitted. Step B4 results in “trace data”, which is an updated record of existing traces, in which the trace parameter values of existing traces are updated based on the peak data. It is realized that the updating also includes deleting traces deemed not to exist (caused by an object being lifted from the touch surface 14, “touch up”), and adding new traces (caused by an object being put down on the touch surface 14, “touch down”).

Following step B4, the process returns to step B1. It is to be understood that one or more of steps B1-B4 may be effected concurrently. For example, the data collection step B1 of a subsequent frame may be initiated concurrently with any one of the steps B2-B4.

The result of the method steps B1-B4 is trace data, which includes data such as positions (xₙₜ, yₙₜ) and area (aₙₜ) for each trace. This data has previously been referred to as touch input data.

### 5. Detect Pressure

The current attenuation of the respective trace can be used for estimating the current application force for the trace, i.e. the force by which the user presses the corresponding touching object against the touch surface. The estimated quantity is often referred to as a “pressure”, although it typically is a force. The process is described in more detail in the above-mentioned application No. 1251014-5. It should be recalled that the current attenuation of a trace is given by the attenuation value that is determined by step B2 (FIG. 5) for a peak in the current attenuation pattern.

According to one embodiment, a time series of estimated force values is generated that represent relative changes in application force over time for the respective trace. Thereby, the estimated force values may be processed to detect that a user intentionally increases or decreases the application force during a trace, or that a user intentionally increases or decreases the application force of one trace in relation to another trace.

FIG. 6 is a flow chart of a force estimation process according to one embodiment. The force estimation process operates on the trace data provided by the data extraction process in FIG. 5. It should be noted that the process in FIG. 6 operates in synchronization with the process in FIG. 5, such that the trace data resulting from a frame in FIG. 5 is then processed in a frame in FIG. 6. In a first step C1, a current force value for each trace is computed based on the current attenuation of the respective trace given by the trace data. In one implementation, the current force value may be set equal to the attenuation, and step C1 may merely amount to obtaining the attenuation from the trace data. In another implementation, step C1 may involve a scaling of the attenuation. Following step C1, the process may proceed directly to step C3. However, to improve the accuracy of the estimated force values, step C2 applies one or more of a number of different corrections to the force values generated in step C1. Step C2 may thus serve to improve the reliability of the force values with respect to relative changes in application force, reduce noise (variability) in the resulting time series of force values that are generated by the repeated execution of steps C1-C3, and even to counteract unintentional changes in application force by the user. As indicated in FIG. 6, step C2 may include one or more of a duration correction, a speed correction, and a size correction. The low-pass filtering step C3 is included to reduce variations in the time series of force values that are produced by step C1/C2. Any available low-pass filter may be used.

Thus, each trace now also has force values, thus, the trace data includes position (xₙₜ, yₙₜ), area (aₙₜ) and force (also referred to as pressure) (pₙₜ) for each trace. These data can be used as touch input data to the gesture interpretation unit 13 (FIG. 1).

The present invention is not limited to the above-described preferred embodiments. Various alternatives, modifications and equivalents may be used. Therefore, the above embodiments should not be taken as limiting the scope of the invention, which is defined by the appending claims.

1. A method for manipulating a graphical user interface, GUI, object, comprising
receiving touch input data indicating touch inputs on a touch surface of a touch sensing device, and from said touch input data:
determining a touch input from a user object on the touch surface, wherein the touch input has a first area a₁ and a geometric centre at a first position; and while continuous contact of said user object with the touch surface is maintained:
determining a change of said geometric centre to a second position;
determining a second area a₂ of the touch input when said geometric centre is in the second position;
comparing said second area a₂ with said first area a₁, and if the second area a₂ is larger than the first area a₁:
determining that a special gesture has been detected;
associating the special gesture with the GUI object; and
manipulating the GUI object according to a predetermined action.

2. The method according to claim 1, comprising determining a user object vector kᵤₛₑᵣ connecting the first position with the second position.

3. The method according to claim 2, wherein said GUI object has an orientation vector k_{GUI}, wherein performing said action includes orienting said GUI object in a predetermined relation between the user object vector kᵤₛₑᵣ and the orientation vector k_{GUI}.

4. The method according to claim 2, wherein the user object vector kᵤₛₑᵣ has a length L, and wherein the method comprises comparing the length L with a threshold; and determining that a special gesture has been detected also based on the comparison.

5. The method according to claim 4, wherein said threshold is a length related to the anatomy of a finger.

6. The method according to claim 4, wherein said threshold depends on the size of the first area a₁ and/or the size of the second area a₂.

7. The method according to claim 1, comprising determining if the second area a₂ of the touch input has the shape of an oval, whereby a further condition for determining that a special gesture has been detected is that the second area a₂ has the shape of an oval.

8. The method according to claim 1, comprising determining if the first area a₁ and the second area a₂ at least partly overlap, whereby a further condition for determining that a special gesture has been detected is that the first area a₁ and the second area a₂ overlap.

9. The method according to claim 1, comprising determining if the second area a₂ covers the first position of the geometric centre, whereby a further condition for determining that a special gesture has been detected is that the second area a₂ covers the first position of the geometric centre.

10. The method according to claim 1, comprising determining a velocity of the geometric centre when moving from the first position to the second position and determining if the velocity is within a certain velocity interval, whereby a further condition for determining that a special gesture has been detected is that the velocity is within the interval.

11. The method according to claim 1, comprising determining from said touch input data that an increased pressure compared to a threshold of the touch input has occurred, before determining that a special gesture has been determined.

12. The method according to claim 1, wherein the touch input data comprises positioning data xₙₜ, yₙₜ and area data aₙₜ for each touch input.

13. A gesture interpretation unit for manipulation of a graphical user interface, GUI, object comprising a processor configured to receive touch input data indicating touch inputs on a touch surface of a touch sensing device, the unit further comprises a computer readable storage medium storing instructions operable to cause the processor to perform operations comprising:
determining a touch input from a user object on the touch surface, wherein the touch input has a first area a₁ and a geometric centre at a first position; and while continuous contact of said user object with the touch surface is maintained:
determining a change of said geometric centre to a second position;
determining a second area a₂ of the touch input when said geometric centre is in the second position;
comparing said second area a₂ with said first area a₁, and if the second area a₂ is larger than the first area a₁:
determining that a special gesture has been detected;
associating the special gesture with the GUI object; and
manipulating the GUI object according to a predetermined action.

14. The unit according to claim 13, comprising instructions for determining a user object vector kᵤₛₑᵣ connecting the first position with the second position.

15. The unit according to claim 14, wherein said GUI object has an orientation vector k_{GUI}, and wherein the unit comprises instructions to perform said action including orienting said GUI object in a predetermined relation between the user object vector kᵤₛₑᵣ and the orientation vector k_{GUI}.

16. The unit according to claim 14, wherein the user object vector kᵤₛₑᵣ has a length L, and wherein the unit comprises instructions for comparing the length L with a threshold; and to determine that a special gesture has been detected also based on the comparison.

17. The unit according to claim 16, wherein said threshold is a length related to the anatomy of a finger.

18. The unit according to claim 16, wherein said threshold depends on the size of the first area a₁ and/or the size of the second area a₂.

19. The unit according to claim 13, comprising instructions for determining if the second area a₂ of the touch input has the shape of an oval, whereby a further condition for determining that a special gesture has been detected is that the second area a₂ has the shape of an oval.

20. The unit according to claim 13, comprising instructions for determining if the first area a₁ and the second area a₂ at least partly overlap, whereby a further condition for determining that a special gesture has been detected is that the first area a₁ and the second area a₂ overlap.

21. The unit according to claim 13, comprising instructions for determining if the second area a₂ covers the first position of the geometric centre, whereby a further condition for determining that a special gesture has been detected is that the second area a₂ covers the first position of the geometric centre.

22. The unit according to claim 13, comprising instructions for determining a velocity of the geometric centre when moving from the first position to the second position, and for determining if the velocity is within a certain velocity interval, whereby a further condition for determining that a special gesture has been detected is that the velocity is within the interval.

23. The unit according to claim 13, comprising instructions for determining from said touch input data that an increased pressure compared to a threshold of the touch input has occurred, before determining that a special gesture has been determined.

24. The unit according to claim 13, wherein the touch input data comprises positioning data xₙₜ, yₙₜ and area data aₙₜ for each touch input.

25. The unit according to claim 13, wherein the touch sensing device is an FTIR-based, Frustrated Total Internal Reflection, touch sensing device.

26. A computer readable storage medium comprising computer programming instructions which, when executed on a processor, are configured to carry out the method of claim 1.

27. A touch sensing device comprising
a touch arrangement comprising a touch surface, wherein the touch arrangement is configured to detect touch inputs on said touch surface and to generate a signal s_{y} indicating said touch inputs;
a touch control unit configured to receive said signal s_{y} and to determine touch input data from said touch input, and generate a touch signal sₓ indicating the touch input data;
a gesture interpretation unit according to claim 13, wherein the gesture interpretation unit is configured to receive said touch signal sₓ.
